(19) United States
(12) Patent Application Publication
(10) Pub. No.: US 2009/0012859 A1
(43) Pub. Date: Jan. 8, 2009

(54) Targeted and Pulled Advertising System for Delivering Product Information Based on Consumer Requests

(75) Inventors: Alan Czeszynski, Pleasanton, CA (US); Arthur L. Cohen, Cupertino, CA (US)

Correspondence Address: STAINBROOK & STAINBROOK, LLP, 412 AVIATION BOULEVARD, SUITE H, SANTA ROSA, CA, 95403, US

(73) Assignee: AERIELLE TECHNOLOGIES, INC., Mountain View, CA (US)

(21) Appl. No.: 12/095,909

(22) PCT Filed: Dec. 2, 2006
(86) PCT No.: PCT/US06/61538

§ 371 Date: Sep. 5, 2008

Related U.S. Application Data
(60) Provisional application No. 60/742,018, filed on Dec. 2, 2005.

(51) Int. Cl. G06Q 30/00

(52) U.S. Cl. 705/14

(57) ABSTRACT

A pull-based method for disseminating marketing information to customers based on specific customer requests through a web based portal connected to a sever with a database of product information. The customer can receive the information via a variety of mediums from a distribution hub connected to the server. Information on consumer choices is stored on the server, which can be collated, ranked, and prioritized for use in tracking consumer requests for information.

### BACKGROUND OF THE INVENTION

1. Technical Field

The present invention relates generally to Internet-based methods of delivering product advertising, and more particularly to a targeted advertising system that delivers specific product information based on an express consumer request.

2. Background Art

Consumers are bombarded by countless advertisements every day. The ads are largely unsolicited and broadly targeted and focus on creating brand or product awareness. Product marketers hope and, to a degree, justifiably believe that consumers will couple their problems or needs with the brand or product presented in the advertisement, and will then act on this awareness to seek further information or make purchasing decisions. The critical point in the purchase decision-making process is at the consumer's evaluation of choices, during which the consumer decides which (if any) product to buy based on information available and on information withheld. The power has shifted from marketer to consumer. By using the Internet, TIVO, digital radio, video-on-demand, and the like, consumers decide what information and entertainment they want and when they want to experience it. (TIVO is a registered trademark of TIVO, Inc of Alviso, Calif.)

Additionally, wireless communication networks have increased rapidly worldwide, enabling many firms to use a new mode of interactive advertising via mobile devices. WAP contributed to the initial implementation, SMS-based marketing, but the most dramatic change occurred after the introduction of the Universal Mobile Telecommunications System (UMTS) and Wideband Code Division Multiple Access (WCDMA). These have enabled many operators to move quickly to Third Generation (3G) standards. Many multinational corporations now take advantage of the high-speed transmission of advertising messaging through sophisticated Internet services.

However, rather than simply pushing messages at consumers blindly, it would be preferable to have consumers actively and intentionally pull the messages. To do this, a product marketer must reach the consumer at this stage to ensure that accurate and complete information is available so that its product is properly and fully evaluated. This objective is difficult to achieve because of the many dimensions of the problem, which include knowing. (1) the identity of the consumer; (2) the product being evaluated; (3) the time of the evaluation; and (4) the proper media with which to deliver the product information sought. A method of product advertising that addresses these four issues has great value for both the consumer and the marketer. Fortunately, recently developed portable media technology and the interactivity of the world wide web and the Internet enable a solution to this problem. That solution is described and disclosed in the following written specification and the annexed drawing.

Other art that shows analogous art is disclosed in a number of issued patents, including the following:

U.S. Pat. No. 7,108,17 to Ergo et al., discloses methods of temporarily providing digital content to a customer based on a request for a desired digital content. At a point of sale, a writeable optically-readable medium may be provided with a changeable portion that, when activated, is adapted to physically change over a period of time (e.g., 3 to 5 days) to a degree that at least part of the medium becomes unreadable by an optical media reading machine. The desired digital content is preferably written on the medium at a point of sale based on the request. The written medium is provided to the customer. The customer pick up the medium at the point of sale, or the medium may be delivered to the customer, for example.

U.S. Pat. No. 7,109,985 to Spencer, et al., describes a system and method that dynamically creates, manipulates and transfers digital images over a communication network on a per request basis in an efficient manner, wherein the composition, format, presentation, and content of the digital images are determined by directives presented at the time of the request. The system includes a parser that takes a request and interprets it into a set of individualized operation commands that will, in sequence, be performed to create or alter an image.

U.S. Pat. No. 7,092,903 to Chow, describes an invention that is directed to facilitating the planning and ordering of a merchandising unit and associated products. A merchandising unit planning screen is presented that displays a representation of a merchandising unit having holders for holding and displaying the products. A product menu is provided for each holder to allow selection of a product from a set of products for each respective holder. Available choices in the product menu of at least one holder are constraining to a subset of the set of products based on predetermined criteria. For each holder for which a product has been selected, a product quantity is determined based on a capacity of the respective holder. An order is generated based on the selected products.

U.S. Pat. No. 7,080,070 to Gavarini, discloses an electronic commerce system that provides various features for assisting customers in locating items and generating orders from a merchant's electronic catalog, and for assisting customers and merchants in communicating about such orders. A user-definable categories feature allows customers and/or merchants to define search queries for searching the electronic catalog, and to store these search queries under user-defined category names for subsequent use.

U.S. Pat. No. 7,055,737 to Tobin, et al., method of obtaining, from a remote location, topic-specific information regarding a product includes: electronically receiving one of a plurality of machine-readable codes electronically navigating to an information resource at a remote location; and displaying the information resource's topic-specific information about the product on an electronic display device.

U.S. Pat. No. 6,925,441 to Jones, et al., A system and method of targeted marketing to consumers, including businesses and associates, based upon the financial characteristics of the consumer, type offer being made and the channel of communication for delivery of the offer. The consumer is characterized based upon financial, behavioral, and socioeconomic factors. The offer is characterized based upon the consumer and the potential for the consumer accepting the offer

U.S. Pat. No. 6,922,672 to Hailpern, et al., discloses a system and method for providing target groups of customers with a plurality of promotions for a plurality of goods. Active customers are tracked for each target group. Active customers can include customers with portable devices, customers with hand-held devices, customers who are viewers of a pay-per-view system and customers who are viewers of a web site. The promotions for each target group are calculated based on the promotional objectives for each target group and the conditions in the operating environment. Selected promotions are sent the active customers for each target group.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein. Specifically, while the aforementioned prior art addresses targeted marketing to consumer groups, providing product related information based on machine readable identification codes or locating desired products from on-line catalogues, none provide a repository of marketing data designed to enable consumers to search for information on specific items to help them make informed purchasing decisions.

### DISCLOSURE OF INVENTION

The present invention is an Internet-based targeted advertising system that delivers specific product information based on an express consumer request.

It is therefore an object of the present invention to provide a new and improved targeted advertising system to enable consumers to request and receive product information based on a customer query in a data repository of product marketing information.

It is another object of the present invention to provide a new and improved targeted and pulled advertising system to deliver requested product marketing information to a variety of viewing means including cell phone displays, computer monitors, PDA or portable music/video players.

A further object or feature of the present invention is a new and improved targeted and pulled advertising system to allow the consumer to choose the preferred choice (channel) of content delivery based on a questionnaire.

It is an even further object of the present invention to record the customer channel in the form of a cookie stored on a display device.

Still other objects and advantages of the present invention will become readily apparent to those skilled in this art from the following detailed description, which shows and describes only the preferred embodiments of the invention, simply by way of illustration of the best mode now contemplated of carrying out the invention. As will be realized, the invention is capable of modification in various obvious respects without departing from the invention. Accordingly, the drawings and description of the preferred embodiment are to be regarded as illustrative in nature, and not as restrictive.

### BRIEF DESCRIPTION OF THE DRAWINGS

The invention will be better understood and objects other than those set forth above will become apparent when consideration is given to the following detailed description thereof. Such description makes reference to the annexed drawing wherein:

FIG. 1 is a flow chart showing the system process flow of the targeted and pulled advertising system of the present invention.

### BEST MODE FOR CARRYING OUT THE INVENTION

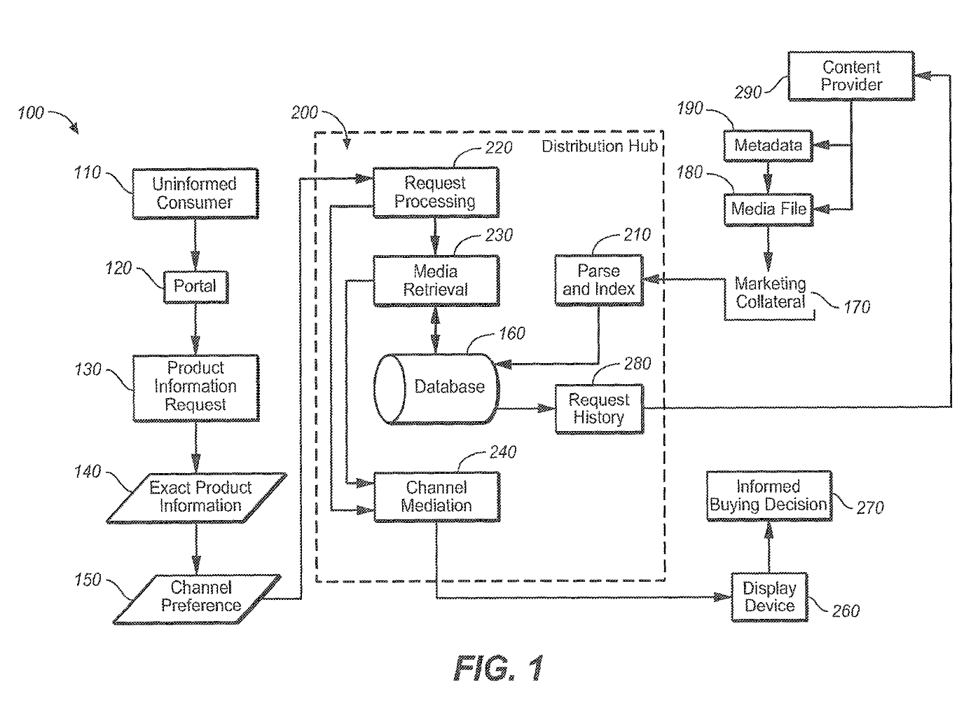

FIG. 1 illustrates a first preferred embodiment of the targeted and pulled advertising system 100 of the present invention, which may be implemented in a number of forms, but consumer use of present computer and communication system technology encourages implementation in two preferred embodiments.

The first preferred embodiment of the inventive system is referred to and characterized herein as “just-in-time” advertising (“JIT”). JIT is an Internet-based advertising service in which a consumer “pulls” an advertisement by expressly asking for and receiving product information so that he or she can make an informed purchase decision. It should be noted preliminarily that while the Internet is currently the ascendent worldwide, publicly accessible network of interconnected computer networks that link and interlink Web pages and other documents comprising the World Wide Web, the present invention is adapted for use on any other suitable electronic data transmission network that uses packet switching (or functional equivalents and alternative communication paradigms) and one or more communication protocols to link the computers or other network access devices of individual consumers with computer networks of businesses and/or institutions, and other individuals. The term “global electronic information network” will be used herein to signify such networks.

In the JIT of the present invention, the information provided pursuant to the request is not of the type comprising conventional flashy content intended to hijack the consumer's attention—that is, it is not intended to comprise part of a brand awareness campaign—rather, it is detailed information about product features, use, options, etc. To be useful to the consumer poised to make a purchase decision, the information must be readily available upon request and it must be easily delivered to the consumer, which is why this embodiment of the inventive system aptly bears the name “Just-in-Time” advertising. The information collected about consumer requests can be collated and provided to advertisers or marketers in the form of trending reports.

The functional structure and topology of the inventive system is organized according to a number of assumptions and predicates, including: (1) a critical mass of networked consumers; (2) an interactive tool for the networked consumers to request information; (3) an electronic repository or pool of stored product information media files; (4) a distribution hub that connects the consumer to the requested information; and (5) a device that displays the media files.

Critical mass of networked consumers. Large pools of consumers are directed to, and naturally congregate at, information or retail portals such as Internet search sites or online stores, e.g., AMAZON.COM®, ITUNES®, and the like. (AMAZON.COM is a registered trademark of Amazon.com, Inc. of South Seattle, Wash. ITUNES is a registered trademark of Apple Computer, Inc., of Cupertino, Calif.) Preferred interactive sites are those in which users routinely make inquiries to the sites through input devices in their interface with the network. Generally (ideally) they receive responses of some kind within a reasonable time. Consumers have become conditioned to interact with the information services offered at these sites, and these sites therefore attract millions of people.

The present invention includes, as a first element, a web-based interface that allows the uninformed consumer 110 to access a portal 120 to make a product information request 130 for the exact product information 140 desired. Such information can be classified according to product type, product model, brand, or any number of other parameters. The consumer's channel preference 150 for delivery of the information content is also provided at this time.

The system next includes an electronic repository or pool of product information media files. This is a vast database 160 (either centralized or distributed). Product marketers provide database extended marketing collateral 170 in media files 180 comprising text, audio, and video information formats—perhaps of 30 seconds to 5 minutes in length—that singly and/or collectively explain product functionality, demonstrate use cases, do comparative analysis, or provide other useful and persuasive information that the marketer feels will positively affect consumer choices and ideally close the deal. The media files contain metadata 190 that make the matching and retrieval easy and straightforward in a manner well known in the art.

Next, the system includes a distribution hub 200. The distribution hub is the match-making service that parses and indexes 210 marketing collateral 170, collects and processes consumer requests 220, and accurately retrieves media 230 relating to the relevant product. After retrieving the media file from the database, it employs channel mediation 240 to effect content delivery 250 to the consumer through the indicated channel preference. As used herein, “channel preference” shall mean a choice of any of a number of electronic means by which multimedia digital files can be distributed, transmitted, downloaded, streamed, and the like, for receipt and playback on portable media players, other mobile electronic devices, or personal computers. At present such “channels” include, among other things, e-mail, lock box, media delivery services, podcasts (and other personal on demand broadcasts), asynchronously replayed media streams, and so forth.

Finally, the system includes a display device 260, the precise form of which may depend on the distribution channel, and will include, among other things, a personal computer, a personal digital assistant, a cell phone, and a digital music/video player. The display device 260 ensures that the now-informed consumer is better equipped to make an informed buying decision 270. Information regarding the request history 280 is sorted and returned to the content provider 290.

Cash Flow and Revenue Model. The JIT advertising system adds value to both the product marketer and the consumer. The product marketer gains an edge in the sales process by providing the consumer the information necessary to make an informed buying decision. The information is delivered to precisely the consumer the company wishes to target at precisely the critical moment in the purchase decision process. The degree of interactivity is high and the impact of the message is high.

The value added by the inventive service can be estimated by determining the cost per customer affected by an advertisement that is part of a broad-based advertising campaign, and applying that directly to each customer request for information. For example, an advertising campaign may reach a very large number of potential customers, but only a fraction of the recipients are genuinely interested or motivated by the ad to make a purchase decision favorable to the advertiser. The true value of the JIT “pulled” ad is the cost for reaching this reduced subset of consumers, e.g. the cost of the traditional campaign divided by the number of positively influenced consumers. The consumer values the time savings, information thoroughness, and the credibility of the information provided. The payment the consumer makes is the time spent giving his or her attention to the advertisement.

The revenue model applicable for such a service is based on charging the product marketer a nominal fee for holding its inventory of media files and maintaining the data, plus a “cost per pull” or “CPP,” analogous to the CPM (cost per thousand views) currently used for online banner advertising. The price to the product marketer may be less than the value outlined above in order to show cost savings to the company: value minus price should be less than the cost per customer influenced by traditional ad campaign. Additionally, there is the potential to collect and sell consolidated, anonymous consumer data back to advertisers.

Process Description for Pull Advertising. In a second preferred embodiment, the inventive targeted advertising system may be characterized simply as “pull” advertising. It is closely related to JIT advertising and allows an internet user to select the type of advertising he receives when visiting web sites. The user selects the product types, brands, or other categories from an advertising portal menu, and those preferences are stored on that user's computer in the form of a cookie. When the user navigates to a site that supports or participates in this pull advertising service, some or all of the advertisements displayed as banners, pop-ups, or keyword links satisfy the preferences of the user. Pull advertising may be implemented in a manner similar to JIT advertising, or it can be fully integrated into the JIT service as an additional product. The revenue model is similar but the price would be more in line with standard CPM costs, since this is the standard measure used for this type of Internet advertising. The distributor can charge service fees and additional CPM fees (as a percentage of the web site's CPM, or based on the additional value added by more focused ad targeting). Note: As used herein, “cookie” means a parcel of text sent or other piece of persistent information about consumer user preferences and on-line behavior sent to a computer when a web page is accessed. They are used for authenticating, tracking, and maintaining specific information about users, such as site preferences and the contents of preferences selections. However, while “cookie” includes the current paradigm of web cookies, it should be taken to include, without limitation, any equivalent electronic means for the selective but persistent storing and transmitting of consumer user information.

As will be immediately appreciated, the pull advertising model of the present invention contrasts sharply with the “push” model of conventional advertising, in which advertising vendors push information content at prospective purchasers regardless of consumer preferences. Furthermore, under the push model of advertising, the content is typically delivered only for the times at which the vendor pays for advertising time and/or coverage. Under the inventive model, advertising need not ever become stale, nor is the delivery to prospective purchasers limited in time. Indeed, an ad could conceivably last for years and still remain current and up-to-date as long as it constituted an appropriate response to consumer requests for general product information and worked effectively worked to influence consumer decisions.

The foregoing disclosure is sufficient to enable those with skill in the relevant art to practice the invention without undue experimentation. The disclosure farther provides the best mode of practicing the invention now contemplated by the inventor.

While the particular method of targeted advertising herein shown and disclosed in detail is fully capable of attaining the objects and providing the advantages stated herein, it is to be understood that it is merely illustrative of the presently preferred embodiment of the invention and that no limitations are intended concerning the detail of construction or design shown other than as defined in the appended claims. Accordingly, the proper scope of the present invention should be determined only by the broadest interpretation of the prospective claims so as to encompass obvious modifications as well as all relationships equivalent to those illustrated in the drawings and described in the specification.

What is claimed as invention is:

1. A targeted and pulled advertising system, comprising;
a plurality of input devices that provide a large pool of consumer users with access to a global electronic information network and to indicate a channel preference;
a portal through which the consumer users can make product information requests;
a web-based network interface co-located with each of said input devices and through which consumer users access said portal;
at least one product information media file electronic database containing a plurality of product information media files provided by one or more product marketers;
a distribution hub for parsing and indexing said product information media files, collecting and processing consumer requests, and retrieving relevant media from said databases in response to user requests;
channel mediation to effect content delivery to the consumer user through the channel preference indicated by the user; and
a plurality of display devices.

2. The system of claim 1, further including means to classify the product information according to a plurality of parameters, including, at a minimum, product type, product model, and brand.

3. The system of claim 1, wherein said database is centralized

4. The system of claim 1, wherein said database is distributed

5. The system of claim 1, wherein said product information media files contain extended marketing collateral comprising files in text, audio, and video information formats

6. The system of claim 1, wherein said product information media files further include metadata.

7. The system of claim 1, wherein at least one display device is co-located with each of said input devices.

8. The system of claim 7, wherein said display devices are selected from the group consisting of personal computer, personal digital assistant, cell phone, digital music player, digital video player, and any and all combinations thereof.

9. The system of claim 1, wherein said web-based network interface includes ad selection means for each of said consumer users to select a preferred type of advertising to receive when visiting subscribing web sites;

10. The system of claim 9, wherein said ad selection means allows the consumer user to select product types, brands, or other categories from an advertising portal menu;

11. The system of claim 10, wherein the ad selections made by a consumer user are stored on that user's input device in the form of a cookie, such that when the user uses that input device to navigate to a web site that participates in the pull advertising service, some or all of the advertisements displayed as banners, pop-ups, or keyword links satisfy the preferences of the user.

12. A pull advertising system, comprising:
a plurality of input devices that provide a large pool of consumer users with access to a global electronic network;
a pluarality of display devices, including at least one display device co-located with each of said input devices;
a web-based network interface co-located with each of said input devices and having and interface including ad selection means for each of said consumer users to select a preferred type of advertising to receive when visiting a subscribing web site, wherein the ad selections made by a consumer user are stored on that user's input device in the form of a cookie;
at least one product information media file electronic database containing a plurality of product information media files provided by one or more product marketers;
a distribution hub for parsing and indexing said product information media files, collecting and processing consumer user ad selection cookies, retrieving relevant media from said databases in response to the user cookies, and displaying the relevant media to the consumer user on the subscriber web site;
whereby when a consumer user uses the input device on which he or she made an ad selection to navigate to a web site that participates in the pull advertising service, some of the advertisements are displayed as banners, pop-ups, or keyword links.

13. The system of claim 12, wherein said ad selection means includes an advertising portal menu that presents the consumer user with choices from which to select product types, brands, or other product differentiating categories, and also means for indicating a channel preference.

14. A method of providing consumers with just-in-time advertising provided by product marketers, comprising the steps of:
providing a product information portal;
providing a plurality of input devices each having a web-based network interface and a display device so that consumer users can access the product information portal on a global electronic network;
compiling and maintaining at least one product information media file electronic database containing a plurality of product information media files;
using a distribution hub for parsing and indexing product information media files, collecting and processing consumer requests, and retrieving relevant media from the databases in response to user requests;

15. The method of claim 14, further including the steps of sorting historical information regarding consumer requests, and returning the sorted information to product marketers.

16. The method of claim 14, further including the step of collecting revenue from product marketers.

17. The method of claim 15, whereby the step of collecting revenue includes charging product marketers a fee for holding and maintaining their respective inventories of media files.

18. The method of claim 14, wherein said revenue collection step includes the step of charging the product marketers a cost per pull.

19. A method of providing consumers with pull advertising, comprising the steps of:
providing a plurality of input devices having web-based network interface and display device, wherein the network interface provides means for a consumer to select a preferred type of advertising to receive when visiting a subscribing web site, and wherein the ad selections are stored on the input device in the form of a cookie, and whereby consumer users can access a global electronic network;
providing at least one product information media file electronic database containing a plurality of product information media files provided by one or more product marketers;
using a distribution hub to parse and indexing the product information media files, collect and process consumer user ad selection cookies, retrieve relevant media from the databases in response to the user cookies, and display the relevant media to the consumer user on the subscriber web site.

20. The method of claim 19, further including the step of charging product marketers service fees.

21. The method of claim 19, further including the step of charging product marketers CPM fees.
